(19) United States
(12) Patent Application Publication
(10) Pub. No.: US 2007/0011050 A1
(43) Pub. Date: Jan. 11, 2007

(54) Digital advertising system

(76) Inventors: Steven Klopf, San Francisco, CA (US); John Yu, Palo Alto, CA (US)

Correspondence Address: PERKINS COIE LLP, P.O. BOX 2168, MENLO PARK, CA, 94026, US

(21) Appl. No.: 11/439,492

(22) Filed: May 22, 2006

Related U.S. Application Data
(60) Provisional application No. 60/683,388, filed on May 20, 2005.
(60) Provisional application No. 60/701,615, filed on Jul. 21, 2005.

(51) Int. Cl. G06Q 30/00

(52) U.S. Cl. 705/14

(57) ABSTRACT

An exemplary embodiment includes an advertising auction system that has an administration server for managing available advertising space and advertising auctions. One or more publishers can list available advertising space at the administration server and one or more advertisers can bid on the available advertising space. The winner can have an advertisement placed at the available advertising space made available by the one or more publishers for a period of time.

### CROSS-REFERENCE TO RELATED APPLICATIONS

This Application claims the benefit of U.S. Provisional Application No. 60/683,388 filed on May 20, 2005, and U.S. Provisional Application No. 60/701,615 filed on Jul. 21, 2005 both of which are incorporated by reference.

### BACKGROUND

Since the advent of large and relatively inexpensive flat-panel displays, their use in public spaces has become ubiquitous. Some examples of where they are typically installed include department stores, health clubs, airport waiting lounges and they have also been scaled to the size of billboards along busy highway corridors. Content for these public displays are sometimes tailored to an environment. For example, a department store may broadcast music videos in their teen clothing department and a health club or airport waiting lounge may be a member of a specialized network that delivers customized content for those settings. In these situations, time may be allotted for advertisements but these proprietary networks typically reach a small number of locations and therefore a small number of potential customers.

In some situations, a broadcast station or cable channel may perhaps be displayed—for example at a health club. Any advertising displayed probably will not reach its target demographic as the gym patrons are there for another purpose and did not select the program for viewing. Additionally, the provider of the display, for example the club owner, is not receiving any benefit from displaying the advertising.

For the digital billboard flat panel, these screens will typically play a set of advertisements over and over or perhaps randomized. The likelihood of those advertisements reaching their target audience is even more remote. It would be quite coincidental for a potential customer to be driving by at the same time an advertisement is displayed that he would be interested in.

In view of the foregoing, it may be useful to provide methods and systems that are capable of tapping into the growing numbers of public flat panel displays such that advertisements can be effectively delivered to a desired demographic at a particular time and/or setting. Additionally, it may be useful for the methods and systems used for the advertisement deployment to be a source of profit for the provider of those method and systems.

The foregoing examples of the related art and limitations related therewith are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for delivering digital advertising involves an auction where an advertiser bids for advertising space. An example of a system according to the technique includes a meta media server, a publisher manager, and an advertising manager. The meta media server can create accounts for participants in a digital media marketplace, upload and manage supply, upload, index and manage demand, search and group available advertising space, reconcile monetization of the available advertising space, approve advertising content and manage rules and procedures for advertising auctions, reporting and analytics.

The publisher manager can represent at least one publisher that lists demand in the meta media server. The advertiser manager can represent one or more advertisers that participate in an auction for at least a portion of the demand. If a specific advertiser wins the auction, the advertiser wins a right to distribute content via the portion of the demand. In one embodiment, supply can include advertisements and may include other content, and demand can include digital signage and other available advertising space and may include other mechanisms for delivering content.

In additional embodiments, the demand can include a public or private digital display, a network of digital displays, a program running on the digital display or the network of digital displays, a web based medium such as a webpage, blog, or internet portal, and/or print media, traditional or digital. In other embodiments, the participants can includes a publisher and one or more advertisers.

In certain embodiments, reconciling monetization of the advertising space can include receiving payment from the specific advertiser for the portion of the demand and compensating the publisher for the specific advertiser's use of the demand. In another embodiment, reconciling monetization can include compensating an operator of the digital media marketplace. In additional embodiments, operator compensation can include revenue share, a publisher fee charged for listing demand, an advertiser fee charged for allowing supply into said digital media marketplace, and/or a fixed fee with a variable transaction fee.

In other embodiments, the publisher can be one of a plurality of publisher managers participating in the digital media marketplace. In one embodiment, the publisher manager can be owned by a digital media marketplace system operator. In another embodiment, the publisher manager can be owned by a party independent from the digital media marketplace system operator. Further, the advertising manager can be owned by the marketplace system operator and/or an independent party.

In additional embodiments, the digital media marketplace can include at least one scheduling/delivery engine for scheduling when advertisements are to be displayed, delivering the advertisements to display locations, playing the advertisements and tracking information related to the playing of the advertisements. The tracking information can be made available in analyzed form to advertisers and publishers. In certain embodiments, the analyzed form includes at least one of reports that confirm that a particular advertisement has run, which mediums the particular advertisement ran on, as well as dates, times, demographics, and return on investment analytics related to the particular advertisement.

In another embodiment, the meta media server can facilitate interactive advertisements. For example, an interactive advertisement can measure consumer input by allowing a consumer who views an interactive advertisement to interact with the advertisement. Additionally, by way of example, the interactive advertisement can include interactive information having at least one of a phone number, a text message number, and a special code. In this example, the viewer of the interactive advertisement can call or input the interactive information into a device which could print or deliver a coupon for the viewer on a product being advertised. This data can be collected and reported back to show effectiveness of said interactive advertisement.

In further embodiments, the demand can include televisions, network of televisions, or programs that run on televisions or networks of televisions, and/or radio, networks of radios, or programs that run on radio or networks of radio. Moreover, in another embodiment, a reverse auction can be utilized for at least a portion of the demand. In one example, the reverse auction can involve a specific advertiser listing advertisements and preferences, and publishers bidding on the listed advertisements.

In other embodiments, the one or more guidelines, procedures, algorithms or other rules of any auction can be defined and set by the publishers. Additionally, in some embodiments, the one or more rules can include at least one of a minimum bid, a block of time or number of rotations for an advertisement to be displayed, and/or a minimum duration of the advertisement and a maximum duration for the advertisement. In further embodiments, the advertisement can be verified for content before being displayed on the available advertising space.

An example of a method according to the technique involves accepting one or more listings of available advertising space from one or more publishers. Bids from one or more advertisers are then accepted. An advertisement from the wining bidder is also accepted. Once accepted the advertisement is sent, over the network, to be displayed on the available advertising space.

Advantageously, the proposed systems and methods provide for a digital advertising system. These systems and methods allow advertisers and publishers to facilitate the publishing of advertisements in an efficient and robust manner. These and other advantages of the present invention will become apparent to those skilled in the art upon a reading of the following descriptions and a study of the several figures of the drawings.

### BRIEF DESCRIPTION OF THE DRAWINGS

Exemplary embodiments are illustrated in the referenced figures of the drawings. It is intended that the embodiments and figures disclosed herein are to be considered illustrative rather than limiting.

FIG. 1 is a block diagram illustrating a Digital Advertising System.

FIG. 2 is a block diagram illustrating a Digital Signage Advertising Business Network.

FIG. 3 is a flowchart illustrating a method for an advertiser to interface with an embodiment of the present invention.

FIG. 4 is a flowchart illustrating a method for a publisher to interface with an embodiment of the present invention.

FIG. 5 is a flowchart illustrating a method for implementing an advertisement auction utilizing an embodiment of the present invention.

FIG. 6 is a block diagram of an embodiment of a network, such as the Internet.

FIG. 7 is a block diagram of an embodiment of a computer.

FIG. 8 is a flowchart illustrating a method for searching for Demand (publishers and available advertising space).

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

Aspects of the claimed embodiments contemplate methods and systems for delivering advertising. In one embodiment, advertising can be delivered to digital displays located in any sort of public setting where a potential for reaching a desired demographic exists. Additionally, advertisements can be displayed on other mediums such as a webpage, mobile device, digital radio, and digital television, among others. Furthermore, in other embodiments, owners of various display mediums can set up rules of availability.

In one embodiment, an account management interface can be provided for the owners of the various display mediums. The account management interface can facilitate a variety of functions, including, but not limited to, allowing owners to create an account, index and group available inventory (using informative and targeting descriptors such as viewer demographics, geographical location, and more), set rules of availability, price inventory, and approve advertisers and advertiser's content runs in the inventory, receive payments, and other administrative and analytical functions.

In another embodiment, an account management interface can be provided for the advertisers. The account management interface can facilitate a variety of functions, including, but not limited to, allowing advertisers to create an account, manage an existing account, upload and manage advertising content, search for and group available advertising inventory to purchase, place bids in an auction for various time slots at specific locations of available inventory, pay for the available inventory, and other administrative and analytical functions. In one embodiment, the winner of an auction, which may or may not be the highest bidder or bidders, can be approved to have advertisements displayed at the selected places and times for a given period. In such an embodiment, the system can gather, schedule, and deliver the advertisements to the appropriate medium. Since a server is controlling the medium which displays the advertisements, the advertisements can be displayed in various media formats.

In the context of this disclosure, some terms can be used interchangeably. For example, and not limitation, “digital display”, “remote display”, “flat panel display”, “screens”, “flat panel”, “digital televisions”, “television screens”, “digital billboard” or the like, including various combinations thereof, generally refers to a large format display in a public space. The displays can be “thin” in comparison to a traditional CRT set but this is not a requirement. Additionally, smaller diameter displays can be utilized and can be dependent on location. For another example, and not limitation, “mobile devices”, “mobile users”, “PDA's”, “palm Pilots”, “Ipods,” or the like, and various combinations thereof, generally refers to digital mobile devices. For another example, but not limitation, “websites”, “web pages”, “Internet portals”, “blogs”, “chat”, “Wiki”, “On line,” or the like, and various combinations thereof, generally refers to Internet web pages. For another example, and not limitation, “radio”, “digital radios”, “radio receivers”, “digital radio receivers,” or the like, and various combinations thereof, generally refers to digital devices that are capable of receiving, decoding, and playing digital radio content.

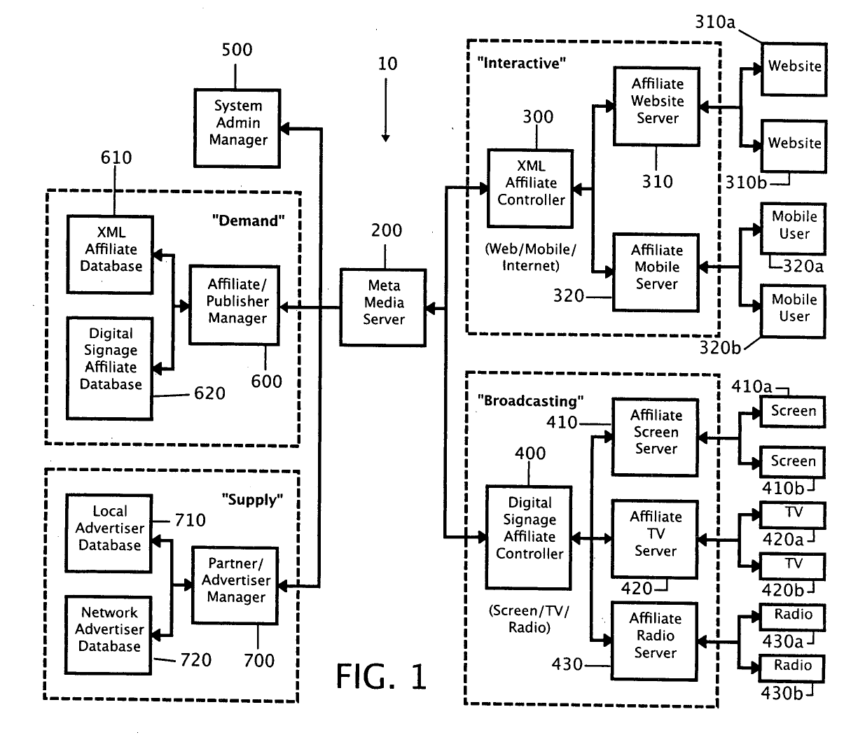

FIG. 1 is a block diagram illustrating a Digital Advertising System 10. The Digital Advertising System can receive, manage, and deliver Supply (e.g., advertisers and advertisements) to Demand (e.g., publishers and available advertising space). Those skilled in the art will recognize that Supply may include or be other types of content besides advertising, and demand may include or be any other suitable mechanism for delivering content. The system 10 includes a Meta Media Server 200 coupled to an XML Affiliate Controller 300, a Digital Signage Affiliate Controller 400, a System Admin Manager 500, an Affiliate/Publisher Manager 600, and a Partner/Advertiser Manager 700.

An XML Affiliate Database 610 and a Digital Signage Affiliate Database 620 are coupled to the Affiliate/Publisher Manager 600. A Local Advertiser Database 710 and a Network Advertiser Database 720 are coupled to the Partner/Advertiser Manager 700. An Affiliate Website Server 310 and a Affiliate Mobile Server 320 are coupled to the XML Affiliate Controller 300. Web Sites 310a and 310b are coupled to the Affiliate Website Server 310. Mobile Users 320a and 320b are coupled to the Affiliate Mobile Server 320. An Affiliate Screen Server 410, an Affiliate TV Server 420, and an Affiliate Radio Server 430 are coupled to the Digital Signage Affiliate Server 400. Screens (digital displays) 410a and 410b are coupled to the Affiliate Screen Server 410. Television Screens 420a and 420b are coupled to the Affiliate TV Server 420. Radios (radio receivers) 430a and 430b are coupled to the Affiliate Radio Server 430.

In one embodiment, an advertiser can access the Partner/Advertiser Manager 700 via the Local Advertiser Database 710 or the Network Advertiser Database 720. The advertiser can create an account, manage an existing account, upload and manage advertising content, search for and group any available advertising inventory that is located in either the XML Affiliate Database 610 or the Digital Signage Affiliate Database 620 or both, place bids in an auction for various time slots at specific locations of available advertising inventory, pay for the available advertising inventory, and/or other administrative and analytical functions.

In certain embodiments, if the advertiser wins the auction, the advertiser is charged the stated price and the advertiser's advertisement(s) are displayed at the selected place and time as defined in the auction. In this embodiment, the Affiliate/Publisher is paid or credited the amount of the winning bid and displays the advertising content on the bargained for medium. Further, in this embodiment, the Digital Media Advertising Service Provider (the system 10 operator) is paid either a percentage of the winning bid or a fixed fee for providing the service.

In another embodiment, a publisher can access the Affiliate/Publisher Manager 600 via the XML Affiliate Database 610 or the Digital Signage Affiliate Database 620. The publisher can create an account, manage an existing account, upload and manage advertising space, search for and group any available advertising request (supply) that is located in the Local Advertiser Database 710 and/or the Network Advertiser Database 720, place bids in an auction among all publishers to provide for available advertising inventory available for advertising request, charge advertising request by the available advertising inventory, and/or other administrative and analytical functions.

Those skilled in the art will recognize that the rules of the auction can take any suitable form, and may be set by the advertisers, the publishers, the operator of the digital advertising system, or by an independent party.

In certain embodiments, if the publisher wins a reverse-auction, the publisher is paid the stated price and the advertisement(s) from the requested advertiser are displayed at the selected place and time from the publisher as defined in the auction. In this embodiment, the Partner/Advertiser is charged the amount of the winning bids and has advertising content displayed on the bargained for medium. Further, in this embodiment, the Digital Media Advertising Service Provider (the system 10 operator) is paid either a percentage of the winning bids or a fixed fee for providing the service.

Optionally, the XML Affiliate Controller 300 and the Digital Signage Affiliate Controller 400 may or may not be owned, managed, or operated by the operators of system 10. The XML Affiliate Controller 300 and the Digital Signage Affiliate Controller 400 can be independently operated and coupled to the Meta Media Server 200 under a contractual agreement. An independent XML Affiliate Controller 300 and an independent Digital Signage Affiliate Controller 400 can index Demand (publishers and available advertising space) in the Affiliate/Publisher Manager 600 and respective XML Affiliate Database 610 and Digital Signage Affiliate Database 620. In this embodiment, the indexing allows the Supply or Request (advertisers and advertisements) to access the remote Demand or Inventory (publishers and available advertising space).

Optionally, the Supply (advertisers and advertisements) in the Partner/Advertiser Manager 700 may or may not be owned by the owners of the system 10. In one embodiment, the operators of the system 10 can own the Local Advertiser Database 710 while not owning the Network Advertiser Database 720. In certain embodiments, the Network Advertiser Database 720 can be populated thru a third party under a contractual agreement between the operators of system 10 and the third party.

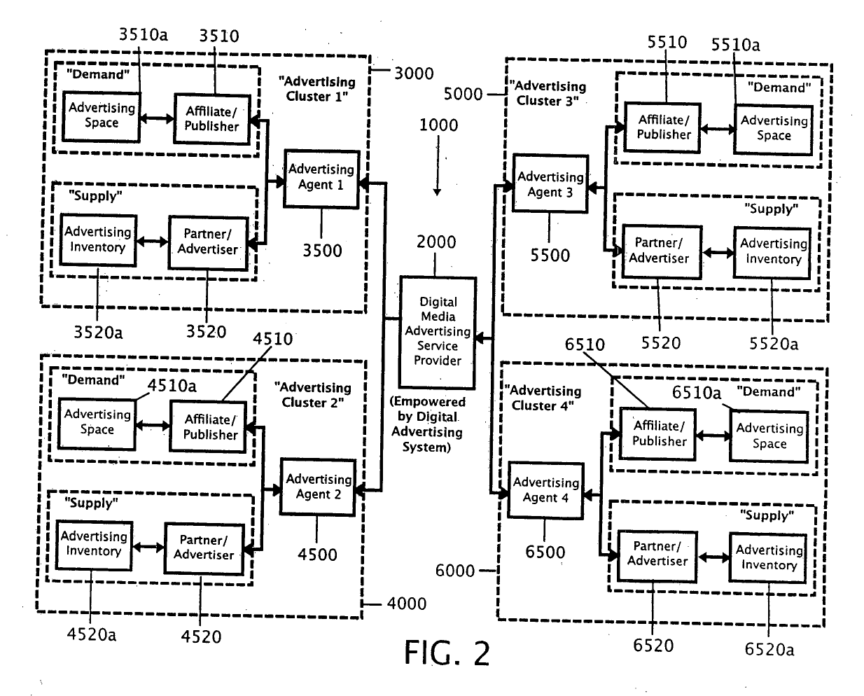

FIG. 2 is a block diagram illustrating a Digital Signage Advertising Business Network “DSABN” 1000. The DSABN can facilitate a number of functions, including, but not limited, the ability to organize, manage, and optimize the balance of advertising supply and advertising demand among the advertising clusters. In the example of FIG. 2, the DSABN 1000 includes a Digital Media Advertising Service Provider 2000. Advertising Cluster 3000, Advertising Cluster 4000, Advertising Cluster 5000 and Advertising Cluster 6000 are coupled to the Digital Media Advertising Service Provider 2000.

As shown in the example of FIG. 2, the Advertising Cluster 3000 includes an Advertising Agent 1 3500 coupled to an Affiliate/Publisher 3510, an Advertising Space 3510a, a Partner/Advertiser 3520 and an Advertising Inventory 3520a. The Advertising Cluster 4000 includes an Advertising Agent 2 4500 coupled to an Affiliate/Publisher 4510, an Advertising Space 4510a, a Partner/Advertiser 4520 and an Advertising Inventory 4520a. The Advertising Cluster 5000 includes an Advertising Agent 3 5500 coupled to an Affiliate/Publisher 5510, an Advertising Space 5510a, a Partner/Advertiser 5520 and an Advertising Inventory 5520a. The Advertising Cluster 6000 includes an Advertising Agent 4 6500 coupled to an Affiliate/Publisher 6510, an Advertising Space 6510a, a Partner/Advertiser 6520 and an Advertising Inventory 6520a.

In one embodiment, Advertising Cluster 3000 operates as an independent digital media advertising network that may or may not be operated by the Digital Media Advertising Service Provider 2000. In such an embodiment, each Advertising Cluster, via an Advertising Agent, can control a network of Supply (advertisers and advertisements), Demand (publishers and available advertising space) and the rules that apply to the buying, selling, and delivery of Supply (advertisers and advertisements) to Demand (publishers and available advertising space). In certain embodiments, the Digital Media Advertising Service Provider 2000 can organize, manage, and optimize the balance of Supply (advertisers and advertisements) and Demand (publishers and available advertising space) among the Advertising Clusters. In one embodiment, the Advertising Cluster can be administered by the corresponding Advertising Agents.

In certain embodiments, the Digital Media Advertising Service Provider 2000 can facilitate an auction of advertising inventory/demand or request/supply (or other buy and sell methodology) within an Advertising Cluster (“Intra-cluster” advertising), or across two or more Advertising Clusters (“Inter-cluster” advertising). This embodiment breaks the business administration boundaries among all Advertising Agents (or Clusters) for truly flexible and effective advertising demand-supply market balance. In one embodiment, the Digital Media Advertising Service Provider 2000 can be compensated by the clusters (Advertiser Agents, or directly by Advertisers or Publishers) for this service via a revenue share (percentage of the buy and sell transaction) or a fixed fee or other method.

Optionally, and referring to an advertisement originating from the Partner/Advertising Manager 700 or the Partner/Advertiser 4050, the advertisement can be required to go through a review process. In certain embodiments, the review process can be performed before and/or after an auction to ensure certain standards are adhered to. The review process can be dependent on the end display location/medium, or other publisher preferences, rules, guidelines, etc. In certain embodiments, the system 10 can handle any sort of media type and can therefore deliver rich and varied content to remote locations. Also, the owners of the remote website, digital display or other end advertising medium such as television, magazine print ads, digital radio, digital audio broadcasts, webcasts and the like can list mediums on the system 10. Advertisers can bid on any available ad space. In one embodiment, owners can set pricing models and rules governing when and how winning advertisements are displayed.

These and other embodiments allow for advertisements to be marketed at specific locations and times when targeted demographics would likely see the advertisement thus alleviating constraints of traditional advertising mediums, such as print and television. For example, and not limitation, a luxury car maker can bid on ad space via a digital display in a city's financial district during commute times when a large probability for high-income financial industry workers exists.

For another example, and not limitation, an athletic shoe manufacturer can bid for displays at health clubs and sports venues. For another example, and not limitation, a product can be advertised on a medium in a retail store where the retail store sells that product, as in a grocery store, auto parts store, or toy store. For another example, and not limitation, an advertisement can be placed in a shopping mall during a holiday season or up to a holiday weekend and awarded to a wining bidder. For another example, and not limitation, an advertisement can be customized for a targeted location such as a city, town, or state.

The advantages of system 10 allow advertisers a more efficient and focused access to potential markets. The consumer also benefits as they are made aware of relevant products. In some embodiments, the Demand (publishers and available advertising space) of system 10 can be provided with income by selling available advertising space to Supply (advertisers and advertisements). In additional embodiments, the operators of system 10 can be provided with income by collecting a percentage of the winning bids and/or charging a fee or other transaction cost for medium owners to list medium availability for advertisers.

In other embodiments, the Demand (publishers and available advertising space) can be pooled together to offer a larger package of available advertising inventory to the Supply (advertisers and advertisements). Revenue from the purchase of the pooled available advertising inventory can be split according to predefined rules. For example, and not limitation, 4 (four) separate property management companies could exist, each managing 10 (ten) shopping malls, and each shopping mall having digital displays (the available advertising inventory). By combining available advertising inventory, advertising space at 40 (forty) malls could be available for a single purchase.

Alternatively, a system as depicted in FIG. 1 and/or FIG. 2 can provide the tools for the Supply (advertisers and advertisements) to be able to pool or group Demand (publishers and available advertising space) in order to purchase more available advertising inventory in a single purchase. The system depicted in FIG. 1 and/or FIG. 2 can settle payments across the pooled or grouped Demand (publishers and available advertising space). In addition, publishers can group or pool available advertising inventory across multiple mediums and make them available as a package purchase. A non-limiting example would be a publisher who owns a website, a radio station, and/or a digital signage network. The publisher can pool or group the website, radio, and/or digital signage available make the advertising inventory available for a single or packaged purchase.

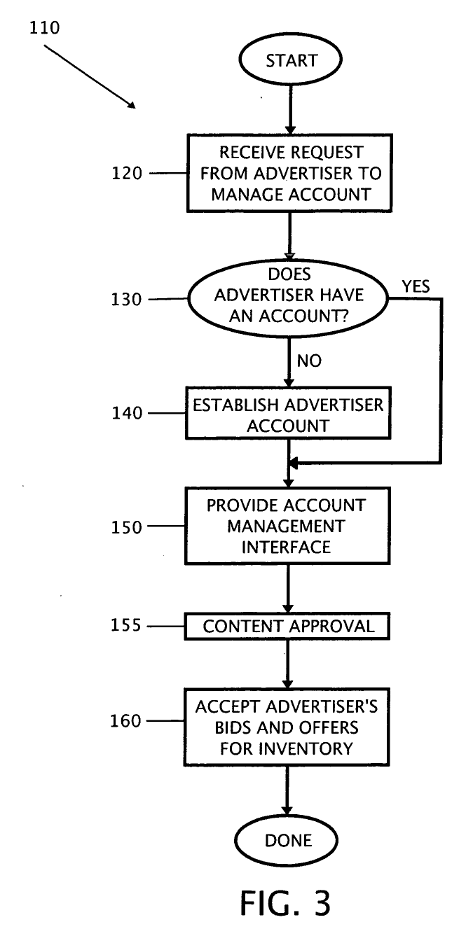

FIG. 3 depicts a flowchart 110 of an example of a method for an advertiser to interface with one embodiment of an advertising system. The flowchart 110 begins with module 120 where a request is received from an advertiser to manage or create an account. In one embodiment, the request is received at a Partner/Advertiser Manager or a Partner Advertiser in a cluster.

In the example of FIG. 3, the flowchart 110 continues at decision point 130 where the request is checked to see if the advertiser has an account. If the advertiser does not have an account (130—No), an account is created and the account management interface is presented at modules 140 and 150. If an account already exists (130—Yes), the advertiser would be routed to module 150 directly.

In the example of FIG. 3, the flowchart 110 continues at module 155 where an advertisement goes through a content approval process. Module 155 can be optional or even performed at a later time such as the time the Advertiser participates in an auction. Finally, at module 160, the advertiser's bids and offers for available ad space can be accepted.

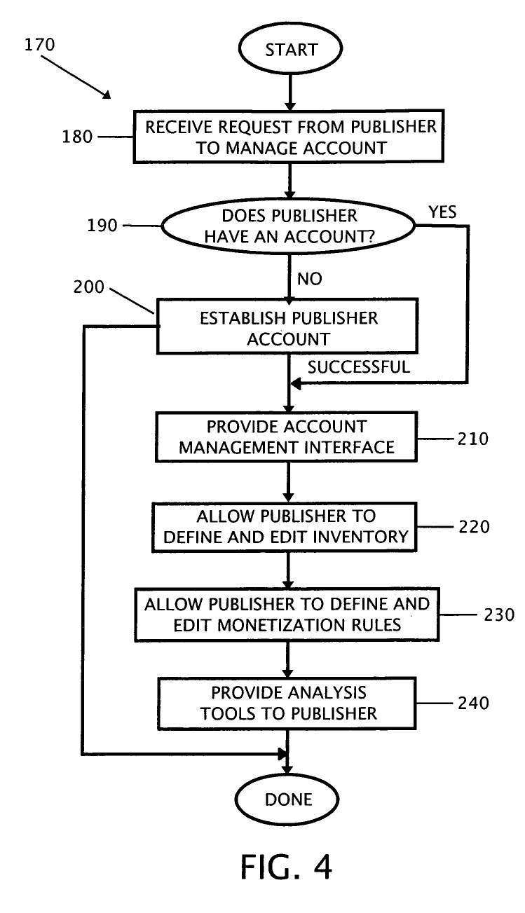

FIG. 4 depicts a flowchart 170 of an example of a method for a publisher to interface with an embodiment of an advertising system. In certain embodiments, a publisher can be any individual, company, organization, or network that has a venue available for advertising. For example, and not limitation, a venue available for advertising can include digital displays, web pages, Internet portals, mobile devices, digital radio, digital television, digital publications, magazines, traditional billboards, newspapers and other traditional advertising venues.

In the example of FIG. 4, the flowchart 170 begins at module 180 where a request is received from a publisher to create or manage an account. In one embodiment, the request is received at an Affiliate/Publisher Manager or an Affiliate/Publisher in a cluster. In other embodiments, the request can be received by any convenient and/or known system capable of receiving a request to manage an account.

In the example of FIG. 4, the flowchart 170 continues at decision point 190 where it is determined whether the publisher has an account. If the publisher does not have an account (190—No), the flowchart 170 continues at module 200 where the publisher can establish a new account and proceed to module 210. Alternatively, the publisher can exit out of system. If the publisher already has an account (190—Yes) or the publisher wishes to establish an account, the flowchart 170 continues at module 210 where the account management interface is presented to the publisher.

In the example of FIG. 4, the flowchart 170 continues at modules 220 and 230 where the publisher can define, index, and edit inventory and define/edit monetization rules for buying advertising space. Finally, at module 240, analysis tools are provided to the publisher. The analysis tools, for example, and not limitation, can provide information on bids placed on inventory and information relating to inventory that has already been purchased.

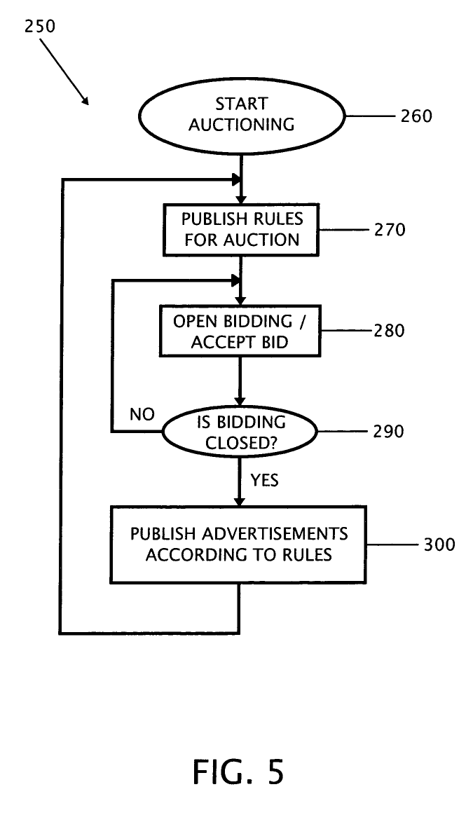

FIG. 5 depicts a flowchart 250 of an example of a method for implementing an advertisement auction. In the example of FIG. 5, the flowchart 250 begins at module 260 where an auction is commenced. The flowchart 250 continues at module 270 where rules for the auction are published. The rules can include a minimum bid, minimum bid relating to the time period the ad could run for, time frame of the auction (start and close), acceptable payment methods (pre-payment required, electronic debit at time advertisement is run, etc.) and any other auction related rules, regulations, and procedures.

In the example of FIG. 5, the flowchart 250 continues at module 280 where bidding is opened and bids can be accepted. The auction continues to run until bidding is closed. The flowchart continues at decision point 290 where it is determined whether the auction is closed. If the auction is not closed (290—No), the flowchart continues at module 280 where bids are accepted. If the auction is closed (290—Yes), the flowchart continues at module 300.

In the example of FIG. 5, the flowchart 250 continues at module 300 where, once bidding is closed, the highest bidder or bidders' win the auction and the highest bidder or bidders' advertisements are published according to the pre-set rules for the lease period. Alternatively, in other embodiments, different rules and criteria may apply to the auction whereas the highest bidder or bidders are not the winners. For example, and not limitation, an algorithm can apply criteria for advertiser ranking combined with the bid price to determine the highest value advertiser to the publisher. A non-limiting example of advertiser criteria can be the advertiser's past payment records or a ranking system based on the effectiveness of prior advertisements run by the advertiser. Payments can then be reconciled between the advertisers, publishers, and system operators.

While the example of FIG. 5 illustrates potential advertisers bidding on available ad space, in other embodiments, a “reverse” auction can be facilitated. For example, and not limitation, an advertiser can set up an auction and set rules for an ad which can include, duration, preferred display medium, etc. Publishers can bid on the chance to display the advertisement. In this embodiment, the lowest bid wins and the advertisement is run on the publisher's medium for the designated lease period.

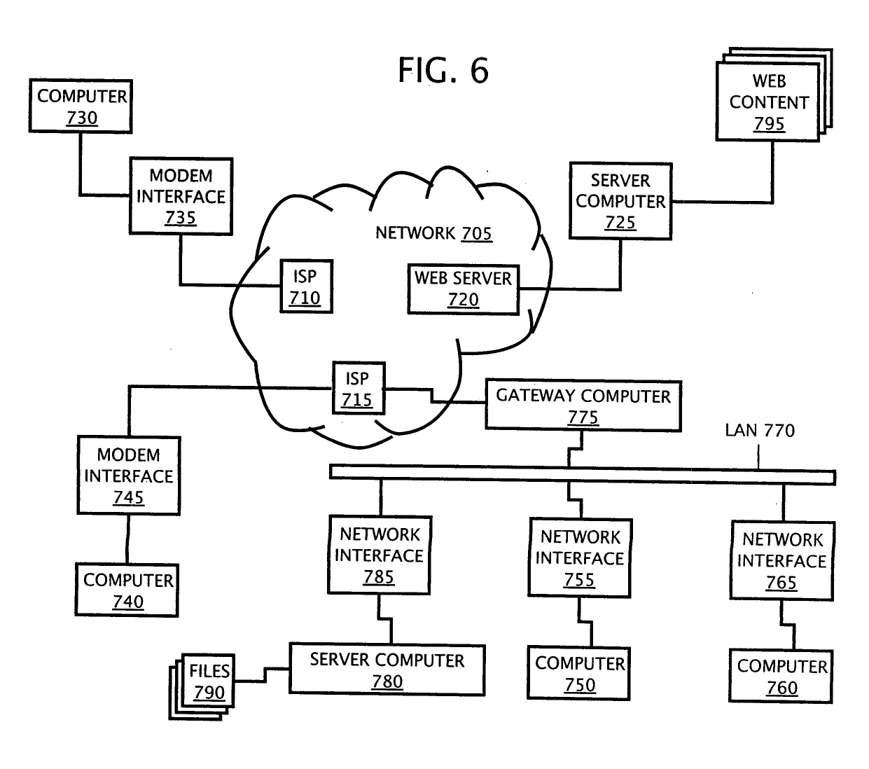

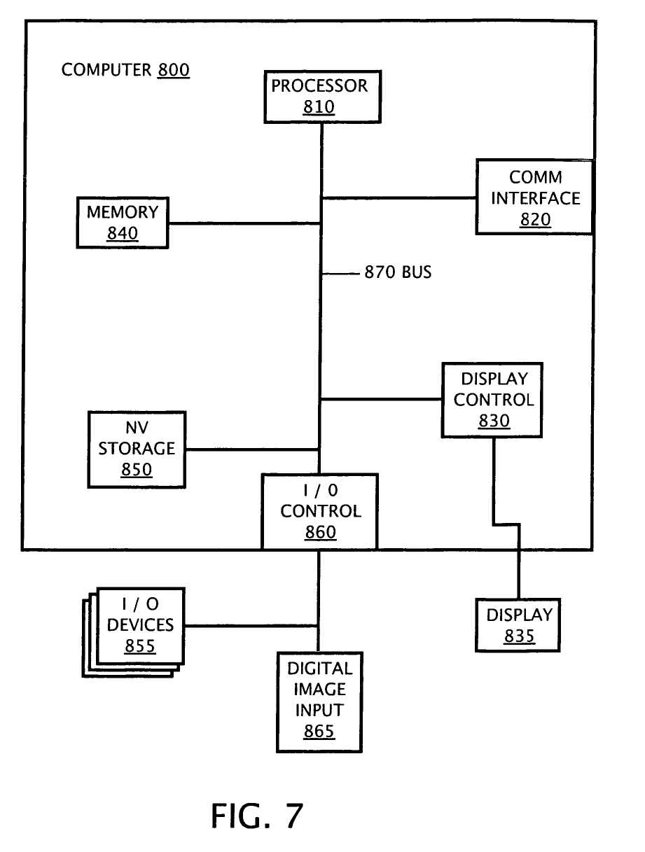

The following description of FIGS. 6-7 is intended to provide an overview of computer hardware and other operating components suitable for performing one or more of the embodiments described herein, but are not intended to limit the applicable environments. In one or more embodiments, the system can be practiced with other computer system configurations, including hand-held devices, multiprocessor systems, microprocessor-based or programmable consumer electronics, network PCs, minicomputers, mainframe computers, and digital audio receivers that may receive digital radio broadcasts from a satellite and the like. In other embodiments, the system can be implemented in distributed computing environments where tasks are performed by remote processing devices that are linked through a communications network.

FIG. 6 is a block diagram of an exemplary embodiment of a network 705, such as the Internet. In one embodiment, the term “Internet” can refer to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

In certain embodiments, access to the Internet 705 is provided by Internet service providers (ISP), such as ISPs 710 and 715. Users on client systems, such as client computer systems 730, 740, 750, and 760 obtain access to the Internet through the Internet service providers, such as ISPs 710 and 715. In certain embodiments, access to the Internet allows users of the client computer systems to exchange information, receive and send e-mails, and view documents, such as documents which have been prepared in the HTML format. In one embodiment, these documents can be provided by web servers, such as web server 720 which is considered to be “on” the Internet. In this embodiment, the web servers are provided by the ISPs, such as ISP 710, although, in other embodiments, a computer system can be set up and connected to the Internet without that system also being an ISP.

In one embodiment, the web server 720 is at least one computer system which operates as a server computer system and is configured to operate with the protocols of the World Wide Web. As shown in the example of FIG. 6, the web server 720 is coupled to the Internet. Optionally, the web server 720 can be part of an ISP which provides access to the Internet for client systems.

As shown in the example of FIG. 6, the web server 720 is coupled to a server computer system 725. The server computer system 725 is further coupled to web content 795, which can be a media database. While two computer systems 720 and 725 are shown in the example of FIG. 6, in other embodiments, the web server system 720 and the server computer system 725 can be one computer system. In such an embodiment, the one computer system can have any number of convenient and/or known software and/or hardware components providing web server functionality and server computer system functionality.

In the example of FIG. 6, client computer systems 730, 740, 750, and 760 can, with the appropriate web browsing software, view HTML pages provided by the web server 720. The ISP 710 can provide Internet connectivity to the client computer system 730 through the modem interface 735. In certain embodiments, the modem interface 735 can be considered part of the client computer system 730. In alternate embodiments, the client computer system 730 can be a personal computer system, a network computer, a Web TV system, or the like.

In the example of FIG. 6, an ISP 715 can provide Internet connectivity for client systems 740, 750, and 760. As shown, client computer system 740 is coupled through a modem interface 745 and client computer systems 750 and 760 are part of a LAN. Interfaces 735 and 745 are generically depicted as a “modem,” which includes, but is not limited to, an analog modem, ISDN modem, cable modem, satellite transmission interface (e.g. “Direct PC”), or other interfaces for coupling a computer system to other computer systems.

Client computer systems 750 and 760 may be coupled to a LAN 770 through network interfaces 755 and 765. The network interfaces 755 and 765 can be an Ethernet network or other similar network interfaces. The LAN 770 is coupled to a gateway computer system 775 which can provide firewall and other Internet related services for the local area network. The gateway computer system 775 is coupled to the ISP 715 to provide Internet connectivity to the client computer systems 750 and 760. In one embodiment, the gateway computer system 775 and the web server system 720 are conventional server computer systems.

Alternatively, a server computer system 780 can be directly coupled to the LAN 770 through a network interface 785. In such an embodiment, the server computer 780 can provide files 790 and other services to the clients 750, 760, without the need to connect to the Internet through the gateway system 775. In other embodiments, any known and/or convenient combination of network components can be configured to implement similar functions.

FIG. 7 depicts a block diagram of an exemplary embodiment of a computer that can be used as a client computer system, a server computer system and/or a web server system. As shown in the example of FIG. 7, the computer system can perform many of the functions of an Internet service provider. The computer system 800 interfaces to external systems through the modem or network interface 820. In certain embodiments, the modem or network interface 820 can be considered to be part of the computer system 800. In alternate embodiments, the interface 820 can be an analog modem, ISDN modem, cable modem, token ring interface, satellite transmission interface (e.g. “Direct PC”), or other interfaces for coupling a computer system to other computer systems.

In the example of FIG. 7, the computer system 800 includes a processor 810. The processor 810 can be any convenient and/or known apparatus that controls execution of data, including, but not limited to an Intel Pentium microprocessor, Motorola Power PC microprocessor or the like. Memory 840 is coupled to the processor 810 by a bus 870. In certain embodiments, memory 840 can be dynamic random access memory (DRAM) and/or static RAM (SRAM). The bus 870 couples the processor 810 to the memory 840, non-volatile storage 850, a display controller 830, and to an input/output (I/O) controller 860.

In one embodiment, the display controller 830 controls a display on a display device 835. In alternate embodiments, the display device 835 can any convenient and/or known display apparatus, including but not limited to, a cathode ray tube (CRT) or liquid crystal display (LCD). In certain embodiments, the input/output devices 855 can include a keyboard, disk drives, printers, a scanner, and other input and output devices, including a mouse or other pointing device. In addition, the display controller 830 and the I/O controller 860 can be implemented with conventional well known technology. For example, and not limitation, a digital image input device 865 can include a digital camera which is coupled to an I/O controller 860 in order to allow images from the digital camera to be input into the computer system 800.

In certain embodiments, the non-volatile storage 850 can be a magnetic hard disk, an optical disk, or another form of storage for large amounts of data. In one embodiment, data can be written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 depicted in FIG. 7 is one example of many possible computer systems which can have different architectures. In other embodiments, personal computers based on an Intel microprocessor can have multiple buses, one of which can be an input/output (I/O) bus for the peripherals and one that directly connects the processor 810 and the memory 840 (often referred to as a memory bus). In such an embodiment, the buses can be connected together through bridge components that perform any necessary translation due to differing bus protocols.

In additional embodiments, network computers can be used as another type of computer system. In such embodiments, the network computer does not include a hard disk or other mass storage, and the executable programs are loaded from a network connection into the memory 840 for execution by the processor 810. In another embodiment, a Web TV system can be a computer system even though certain input or output devices are not available.

In addition, the computer system 800 can be controlled by operating system software. The operating system software can include a file management system, such as a disk operating system. One example of an operating system software with its associated file management system software is the family of operating systems known as Windows® from Microsoft Corporation of Redmond, Wash. Another example of an operating system software with its associated file management system software is the LINUX operating system. In one embodiment, the file management system is stored in the non-volatile storage 850 and causes the processor 810 to execute the various acts required by the operating system.

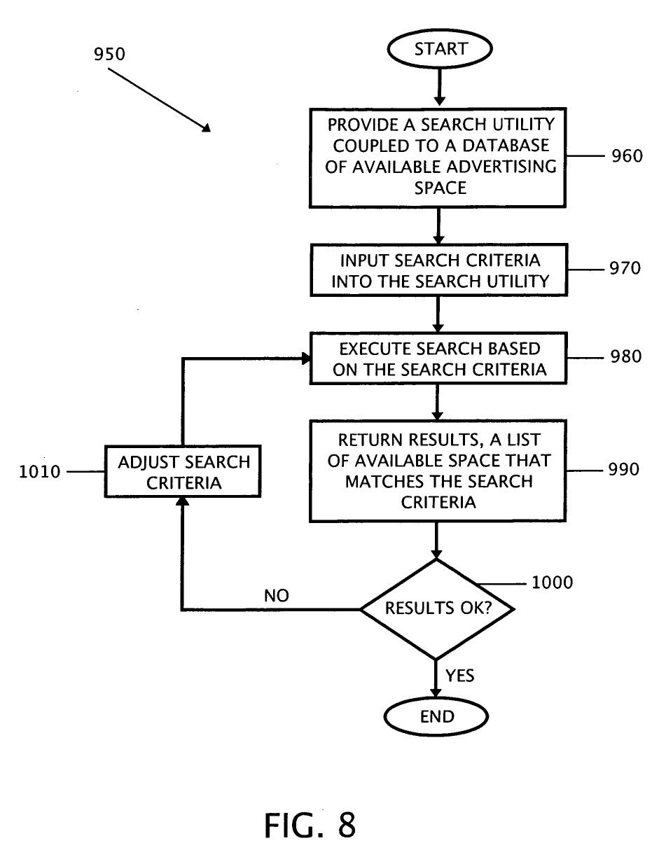

FIG. 8 depicts a flowchart 950 of an example of a method for searching for available advertising space. In the example of FIG. 8, the flowchart 950 begins at module 960 where a search utility is provided. The search utility can be coupled to a database of available advertising space.

In the example of FIG. 8, the flowchart 950 continues at module 970 where search criteria are entered into the search utility. Once the search criteria are entered, the flowchart 950 continues at module 980 where a search is executed based on the entered search criteria. Following the execution of the search, the flowchart 950 continues at module 990 where a result list of available space is returned.

In the example of FIG. 8, the flowchart 950 continues at decision point 1000 where the results are evaluated. If the results of the search are not satisfactory (1000—No), the flowchart 950 continues at module 1010 where search criteria can be adjusted and a new search can be executed. If the results are satisfactory (1000—Yes), the flowchart 950 ends. In other embodiments, the method can further include a step of reserving or saving as a favorite, the advertising space that was included in the results.

Similar to the previously described bidding system for available advertising space, the available advertising space can be located in a plurality of formats. For example, and not limitation, the advertising space can be on public digital displays, web pages, web portals, mobile devices, print media, digital print media, television, digital television, radio and digital/satellite radio. In one embodiment, radio can further be delineated into AM and FM bands.

In other embodiments, search criteria, by way of non-limiting example, can include price, geographical location, location within a facility (such as a shopping mall; food court or walk way), viewer demographics, advertising display time, venue-type, past history of purchases, favorites, and closed networks. In certain embodiments, closed networks can be clusters and include a set of networked public digital displays, websites, radio stations, television stations, mobile devices, or other medium type at a specific location or collection of similar locations. The clusters may allow for the balance or unsold Demand (publishers and available advertising space) in closed network to be available for purchase.

In one embodiment, once results with desirable characteristics are obtained from search criteria, the previously described bidding system can be utilized to bid on the Demand (publishers and available advertising space) contained in the results list. In additional embodiments, the previously described methods of pooling or grouping the Demand (publishers and available advertising space) by the advertiser and participating in auctions, saving as favorites, etc., can be performed.

In other embodiments, location-type search criteria can take various forms and combinations of forms. For example, and not limitation, the location search criteria can include, a country, state or province, regions (multi-states or regions in a state), and/or one or more cities and districts within a city. Other non limiting examples of search criteria can include home pages of web site portals, an Arts section (web pages) of the New York Times digital newspaper, Internet Protocol or profile based geo targeting of a web surfer who visits a web page (for example, and not limitation, a surfer determined to be located in San Francisco, Calif. visiting a web page or web site), radio broadcasts in a particular city, etc. Alternatively, location search criteria can include any combinations thereof. For example, and not limitation, a combination location search can include financial districts in several cities.

In one embodiment, to facilitate a large purchase, a pool of owners or publishers can combine available advertising space. In this embodiment, revenue generated from the pooling can be shared according to pre-defined rules. For example, and not limitation, four property management groups may exist and each controls ten shopping malls. By combining inventory, advertising space at forty malls can be available for a single purchase.

In alternate embodiments, category-type search criteria can take various forms and combinations of forms. For example, and not limitation, a category-type search can include venues such as casinos, airports, shopping malls, subways, transit stations, medical offices, professional buildings, golf shops, retail outlets, and beauty salons. For another example, and not limitation a category-type search can include transportation such as vehicles, trains, subway transports, ferries, boats, and aircraft. In other examples, and not limitation, category type-searching can include web sites, blogs, internet portals, news portals, lifestyle web pages, keywords relating to content on a webpage, television programs relating to travel, cooking, news sports, and entertainment, radio programs relating to sports, news, travel, and political topics, and mobile devices such as cell phones and PDA's. In alternate embodiments, a category-type search can be a combination thereof. A non-limiting example of a combination category-type search can be a television program on travel that is being broadcast in an airport.

In various embodiments, demographic-type search criteria can take various forms and combinations of forms. For example, and not limitation, demographics can include age, gender, typical income, interests, occupation, language, educational level, marital status and ethnicity. For example and not limitation, a demographics search can include teenagers between the ages of 16 (sixteen) and 19 (nineteen). In alternate embodiments, a category-type search can be a combination thereof. A non-limiting example of a combination demographic-type search can be German speaking financial executives with incomes greater than $60,000.00 (sixty thousand dollars).

In another embodiment, search criteria can include pricing tiers. In one embodiment, the pricing tiers can include a low, middle and high pricing tier. For example, and not limitation, a high pricing tier can include premium advertising venues that are seen by a large number of people during desirable timeframes. By way of a non-limiting example, a premium advertising venue can include digital screens in a main subway terminal in a major city during peak travel hours. Additionally, the viewer can have desirable demographics for a given advertisement. Continuing with the example, a middle pricing tier can be less expensive than the high pricing tier and can have decent but not as desirable characteristics as the higher-level tier. In a similar manner, a low pricing tier can have advertising space that is less expensive than the middle tier with less desirable advertising space characteristics.

In an additional embodiment, medium-type search criteria can take various forms and combinations of forms. By way of a non-limiting example, medium-type searches can include digital screens, web pages, portals, blogs, magazines, digital publications, digital radio, radio, digital television, television, and mobile devices. In alternate embodiments, a medium-type search can be a combination thereof. A non-limiting example of a combination medium-type search can be a digital television program and a corresponding web site.

Optionally, combinations of all search criteria can be used to obtain desired results. By way of a non-limiting example, a search for Demand (publishers and available advertising space) in websites and digital radio targeting college students in the State of California who are studying in the field of finance can be performed. Furthering the non-limiting example, the results can be broken down by pricing tiers.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A digital media marketplace for bringing together supply and demand, wherein supply includes advertisements and may include other content, and wherein demand includes digital signage and other available advertising space and may include other mechanisms for delivering content, said digital media marketplace comprising:
a meta media server for
creating accounts for participants in said digital media marketplace;
uploading and managing supply;
uploading, indexing and managing demand;
searching and grouping available advertising space;
reconciling monetization of said available advertising space;
approving advertising content; and
managing rules and procedures for advertising auctions, reporting and analytics;
a first publisher manager representing at least one publisher that lists a first demand in said meta media server;
a first advertiser manager representing one or more advertisers that participate in an auction for at least a portion of said first demand, wherein a specific advertiser that wins said auction wins a right to distribute content via said portion of said first demand.

2. A digital media marketplace as recited in claim 1, wherein said demand includes a public or private digital display or network of digital displays or a program running on said digital display or said network of digital displays.

3. A digital media marketplace as recited in claim 1, wherein said demand includes a web based medium such as a webpage, blog, or internet portal.

4. A digital media marketplace as recited in claim 2, wherein said demand further includes print media such as traditional or digital print media.

5. A digital media marketplace as recited in claim 1, wherein said participants in said digital media marketplace include said first publisher and said one or more advertisers.

6. A digital media marketplace as recited in claim 1, wherein reconciling monetization of said advertising space includes receiving payment from the specific advertiser for said portion of said first demand.

7. A digital media marketplace as recited in claim 1, wherein said first publisher manager is one of a plurality of publisher managers participating in said digital media marketplace.

8. A digital media marketplace as recited in claim 7, wherein said first publisher manager is owned by a digital media marketplace system operator.

9. A digital media marketplace as recited in claim 8, wherein a second publisher manager is owned by a party independent from said digital media marketplace system operator.

10. A digital media marketplace as recited in claim 1, wherein said first advertiser manager is owned by a digital media marketplace system operator.

11. A digital media marketplace as recited in claim 10 further including a second advertiser manager, wherein said second advertiser manager is owned by a party independent from said digital media marketplace system operator.

12. A digital media marketplace as recited in claim 1 further comprising:
at least one scheduling/delivery engine for
scheduling when advertisements are to be displayed;
delivering said advertisements to display locations;
playing said advertisements; and
tracking information related to the playing of said advertisements.

13. A digital media marketplace as recited in claim 12, wherein said tracking information is made available in analyzed form to advertisers and publishers.

14. A digital media marketplace as recited in claim 13, wherein said analyzed form includes at least one of reports that confirm that a particular advertisement has run, which mediums said particular advertisement ran on, as well as dates, times, demographics, and return on investment analytics related to said particular advertisement.

15. A digital media marketplace as recited in claim 1 wherein said meta media server facilitates interactive advertisements.

16. A digital media marketplace as recited in claim 15, wherein an interactive advertisement enables measuring consumer input by allowing a consumer who views said interactive advertisement to interact with the advertisement.

17. A digital media marketplace as recited in claim 16, wherein said interactive advertisement includes interactive information having at least one of a phone number, a text message number, and a special code, wherein said viewer of said interactive advertisement can call or input said interactive information into a device which could print or deliver a coupon for the viewer on a product being advertised, whereby this data can be collected and reported back to show effectiveness of said interactive advertisement.

18. A digital media marketplace as recited in claim 1 wherein said demand includes televisions, network of televisions, or programs that run on televisions or networks of televisions.

19. A digital media marketplace as recited in claim 1, wherein said demand includes digital displays, a web based medium, and one or more mobile devices, and wherein said meta media server facilitates interactive advertisements.

20. A digital media marketplace as recited in claim 1 wherein said demand includes radio, or networks of radios, or programs that run on radio or networks of radio.

21. A digital media marketplace as recited in claim 1 wherein a reverse auction is utilized for at least another portion of said demand, wherein a specific advertiser of the one or more advertisers lists advertisements and preferences, and publishers bid on said listed advertisements such that one or more advertisers pay a winning publisher an amount equal to a winning bid.

22. A digital media marketplace as recited in claim 1 wherein one or more guidelines, procedures, algorithms or other rules of any auction are defined and set by publishers.

23. A digital media marketplace as recited in claim 22 wherein said one or more rules includes at least one of a minimum bid, a block of time or number of rotations for an advertisement to be displayed, a minimum duration of the advertisement and a maximum duration for the advertisement.

24. A digital media marketplace as recited in claim 1 wherein an advertisement is verified for content before being displayed on said available advertising space.
said first publisher for said specific advertiser's use of said first demand.

25. A digital media marketplace as recited in claim 6, wherein said monetization includes compensating an operator of said digital media marketplace for facilitating said digital media marketplace.

26. A digital media marketplace as recited in claim 25 wherein operator compensation includes revenue share.

27. A digital media marketplace as recited in claim 25 wherein operator compensation includes a publisher fee charged for listing demand.

28. A digital media marketplace as recited in claim 25 wherein operator compensation includes an advertiser fee charged for allowing supply into said digital media marketplace.

29. A digital media marketplace as recited in claim 25 wherein operator compensation includes a fixed fee with a variable transaction fee.

30. A digital media marketplace as recited in claim 1, wherein said specific advertiser is one of a plurality of advertisers that wins said auction and thus wins rights to distribute content.

31. A digital media marketplace as recited in claim 1 wherein said demand includes a mobile device, or networks of mobile devices, or programs that run on mobile devices or networks of mobile devices.

32. A digital media marketplace for bringing together supply and demand, wherein supply includes advertisements and may include other content, and wherein demand includes digital signage and other available advertising space and may include other mechanisms for delivering content, said digital media marketplace comprising:
a meta media server for
uploading and managing supply;
uploading, indexing and managing demand;
searching and grouping available advertising space;
reconciling monetization of said available advertising space;
approving advertising content; and
managing rules and procedures for advertising auctions, reporting and analytics;
a first advertiser manager representing advertisers having advertising content, said advertisers being willing to pay to have said advertising content published; and
a first publisher manager representing publishers that list demand on said meta media server, said publishers participating in a reverse auction wherein reverse auction winners win a right to be paid for publishing advertisements.

33. A digital media marketplace for bringing together supply and demand, wherein supply includes advertisements, and wherein demand includes digital signage and other available advertising space, said digital media marketplace comprising:
a first advertiser manager representing advertisers having advertising content;
a first publisher manager representing publishers having demand, said demand including all five of 1) a public or private digital display or network of digital displays or a program running on said digital display or said network of digital displays, 2) a web based medium such as a webpage, blog, or internet portal, 3) print media, 4) radio airtime, and 5) a mobile device or a network of mobile devices; and
a meta media server for
uploading and managing supply;
uploading, indexing and managing demand;
searching and grouping available advertising space;
reconciling monetization of said available advertising space; and
managing auctions between supply and demand.

33. A digital signage advertising business network comprising:
a plurality of digital advertising systems each having:
at least one supply manager for managing advertising content and advertisers;
at least one demand manager for managing available advertising space and publishers controlling said available advertising content; and
a mechanism for connecting supply and demand; and
a digital media advertising service provider coupled to said plurality of digital advertising systems and operable to load balance excess supply and demand across said plurality of digital advertising systems.

34. A method for a networked advertising auction comprising:
accepting one or more listings of available advertising space from one or more publishers, over a network, said available advertising including digital signage and web based advertising space;
accepting one or more bids from one or more advertisers, over the network, to utilize the available advertising space;
accepting an advertisement, over the network, from a bidder or bidders of the one or more advertisers that wins an auction; and
sending the advertisements, over the network, to a publisher of the one or more publishers to be displayed on the available advertising space.

35. A method as recited in claim 34 further comprising monetizing publication of said advertisements.

36. A method as recited in claim 34 further including a reverse auction wherein publishers bid for a right to publish advertisements.

37. A computer implemented method for providing a digital media marketplace for bringing together supply and demand, wherein supply includes advertisements, and wherein demand includes digital signage and other available advertising space, said method comprising:
uploading and managing supply provided by a plurality of advertisers;
uploading, indexing and managing demand provided by a plurality of publishers, wherein demand includes a public or private digital display or network of digital displays or a program running on said digital display or said network of digital displays, said demand further including at least one of 1) a web based medium such as a webpage, blog, or internet portal, 2) print media, 3) radio airtime, and 4) a mobile device or a network of mobile devices;
searching and grouping available advertising space; and
reconciling monetization of said available advertising space; and
managing auctions between supply and demand.
